(19) United States
(12) Patent Application Publication
(10) Pub. No.: US 2020/0162643 A1
(43) Pub. Date: May 21, 2020

(54) METHOD AND SYSTEM FOR GENERATING MULTI-FACETED IMAGES USING VIRTUAL CAMERA

(71) Applicant: CJ CGV CO., LTD., Seoul (KR)

(72) Inventors: Ki Su PARK, Seoul (KR); Hae Jeong KOH, Seoul (KR); Kyung Yoon JANG, Seoul (KR)

(21) Appl. No.: 16/220,341

(22) Filed: Dec. 14, 2018

(30) Foreign Application Priority Data
Nov. 21, 2018 (KR) 10-2018-0144377

(51) Int. Cl. H04N 5/222; H04N 5/232

(52) U.S. Cl. CPC H04N 5/2224; H01L 27/14601; H04N 5/23238

(57) ABSTRACT

Disclosed herein is a method of generating multi-faced images. The method includes adjusting, by a multi-faced image generation apparatus, a photographing configuration of a virtual camera, configuring, by the multi-faced image generation apparatus, a photographing section of the adjusted virtual camera, and generating, by the multi-faced image generation apparatus, matched first multi-faced images captured by the virtual camera based on the configured photographing section.

### CROSS REFERENCE TO RELATED APPLICATION

The present application claims the benefit of Korean Patent Application No. 10-2018-0144377 filed in the Korean Intellectual Property Office on Nov. 21, 2018, the entire contents of which are incorporated herein by reference.

### BACKGROUND OF THE INVENTION

### Technical Field

The present invention relates to a method and system for generating multi-faced images using a virtual camera and, more particularly, to a method capable of generating multi-faced images which can be played back on a multi-faced movie screen by processing images captured by a virtual camera and an apparatus performing the same.

### Background Art

A common theater is managed in the form of a system in which a single large-sized screen is positioned on the side opposite audiences and a two-dimensional (2-D) image or three-dimensional (3-D) image is projected on the screen. The 3-D image is for providing users with a stereoscopic image, and an audience can watch the 3-D image using specially fabricated eyes or device.

Such a 3-D image can provide audiences with a stereoscopic image, but merely provides audiences with an image projected on a single screen. Such a 3-D image has problems in that a degree of immersion for an image itself is low and sensitive audiences may feel dizzy or sick when they watch the image for a long time.

Accordingly, a multi-faced screening system capable of providing a stereoscopic effect similar to a 3-D image through a 2-D image has been disclosed. The multi-faced screening system means a technology in which display surfaces are disposed in left and right wall surfaces, a ceiling surface or a bottom surface connected to a screen, respectively, in addition to the screen on the side opposite audiences and a single synchronized image is projected on the display surfaces connected to the screen, thus being capable of providing audiences with a stereoscopic effect and a feeling of immersion.

Multi-faced images projected on the multi-faced screening system have been photographed in such a manner that a single subject for photography is photographed using a plurality of cameras capable of capturing images at different points of time. However, the multi-faced screening system has problems in that a user must edit overlapped regions one by one and additionally perform a task for synchronizing the size and horizontality in order to produce an image finally projected on a multi-faced movie screen because photographed regions are overlapped depending on the photographing configurations of the plurality of cameras. Furthermore, the multi-faced screening system has a problem in that images projected on the left and right display surfaces may be distorted and viewed by audiences at the back seats depending on the structure of a movie screen.

Accordingly, it is necessary to develop a method and apparatus capable of generating multi-faced images in a more convenient manner, and the present invention relates such a method and apparatus.

### DISCLOSURE

### Technical Problem

Embodiments of the present invention relate to a multi-faced image generation apparatus capable of easily performing the post production of multi-faced images captured by a virtual camera in a process of projecting the multi-faced images on a multi-faced image system.

Embodiments of the present invention relate to a method of generating an image so that an audience can watch multi-faced images, projected on a multi-faced screening system, without distortion even if the audience sits down on any seat.

Technical objects to be achieved in the present invention are not limited to the above-described technical objects, and other technical objects not described above may be evidently understood by a person having ordinary skill in the art to which the present invention pertains from the following description.

### Technical Solution

A method of generating multi-faced images using a virtual camera according to an embodiment of the present invention includes adjusting, by a multi-faced image generation apparatus, a photographing configuration of a virtual camera, configuring, by the multi-faced image generation apparatus, a photographing section of the adjusted virtual camera, and generating, by the multi-faced image generation apparatus, matched first multi-faced images captured by the virtual camera based on the configured photographing section.

In accordance with an embodiment, the method may further include the step of previewing multi-faced images being captured by the virtual camera based on the photographing section prior to the step of generating the first multi-faced images.

In accordance with an embodiment, the method may further include the step of warping the first multi-faced images after the step of generating the first multi-faced images.

In accordance with an embodiment, the step of warping the first multi-faced images may include the steps of checking a parameter indicative of the structure of a movie screen on which the first multi-faced images are projected and setting a correction ratio for each display surface of the first multi-faced images based on the checked parameter.

In accordance with an embodiment, the method may further include the step of generating and previewing a second multi-faced image to which the ratio has been applied after the step of setting the correction ratio of each display surface.

In accordance with an embodiment, the method may further include the step of determining the set correction ratio after the step of previewing the second multi-faced image and generating a third multi-faced image by applying the determined correction ratio to the matched first multi-faced images.

In accordance with an embodiment, the step of adjusting the photographing configuration may include the step of adjusting horizontal and vertical resolution of at least one of a center display surface and left and right or up and down display surfaces of a movie screen if the virtual camera is a single virtual camera.

In accordance with an embodiment, the step of generating the first multi-faced images may include the step of generating the first multi-faced images by dividing a first multi-faced image, captured by a single virtual camera, based on the display surfaces of a movie screen if the virtual camera is the single virtual camera.

In accordance with an embodiment, the virtual camera may include a plurality of virtual cameras. The plurality of virtual cameras may include a main virtual camera corresponding to the center display surface of a movie screen and sub-virtual cameras disposed on the left and right or top and bottom of the main virtual camera.

In accordance with an embodiment, the plurality of virtual cameras may be disposed in the same center axis.

In accordance with an embodiment, the step of adjusting the photographing configuration may include the step of adjusting photographing configurations of the sub-virtual cameras so that the photographing region of the main camera and the photographing regions of the sub-virtual cameras are connected.

In accordance with an embodiment, the photographing configuration may include one or more of the focal distance or resolution of the plurality of virtual cameras.

A multi-faced image generation apparatus according to another embodiment of the present invention includes a virtual camera adjustment unit configured to adjust a photographing configuration of a virtual camera, a photographing configuration unit configured to configure a photographing section of the virtual camera having the photographing configuration adjusted, a multi-faced image generation unit configured to generate matched first multi-faced images captured by the virtual camera having the photographing section configured, and a processor configured to control one or more of the virtual camera adjustment unit, the photographing configuration unit and the multi-faced image generation unit.

In accordance with an embodiment, the multi-faced image generation apparatus may further include a preview generation unit configured to preview multi-faced images being captured by the virtual camera based on the photographing section configured by the photographing configuration unit.

In accordance with an embodiment, the multi-faced image generation apparatus may further include an image warping unit configured to warp the first multi-faced images generated by the multi-faced image generation unit.

In accordance with an embodiment, the image warping unit may be configured to check a parameter indicative of the structure of a movie screen on which the first multi-faced images are projected and to set a correction ratio for each display surface of the first multi-faced images based on the checked parameter.

In accordance with an embodiment, the preview generation unit may be configured to generate and preview a second multi-faced image to which the ratio has been applied after the correction ratio of each display surface is set.

In accordance with an embodiment, the image warping unit may be configured to determine the set correction ratio after the step of previewing the second multi-faced image and to generate a third multi-faced image by applying the determined correction ratio to the matched first multi-faced images.

In accordance with an embodiment, the virtual camera adjustment unit may be configured to adjust horizontal and vertical resolution of at least one of the center display surface and left and right or up and down display surfaces of a movie screen if the virtual camera is a single virtual camera.

In accordance with an embodiment, the multi-faced image generation unit may be configured to generate the first multi-faced images by dividing a first multi-faced image, captured by a single virtual camera, based on display surfaces of a movie screen if the virtual camera is the single virtual camera.

In accordance with an embodiment, the virtual camera may include a plurality of virtual cameras. The plurality of virtual cameras may include a main virtual camera corresponding to a center display surface of a movie screen and sub-virtual cameras disposed on left and right or top and bottom of the main virtual camera.

In accordance with an embodiment, the plurality of virtual cameras may be disposed in the same center axis.

In accordance with an embodiment, the photographing configuration unit may be configured to adjust the photographing configurations of the sub-virtual cameras so that the photographing region of the main camera and the photographing regions of the sub-virtual cameras are connected.

In accordance with an embodiment, the photographing configuration may include one or more of the focal distance or resolution of the plurality of virtual cameras.

### Advantageous Effects

In accordance with an embodiment of the present invention, there is an effect in that an integrated multi-faced image can be generated using a virtual camera.

Furthermore, images projected on a plurality of display surfaces within a movie screen are warped by taking into consideration distortion according to locations. Accordingly, there is an effect in that a feeling of immersion can be improved because an audience can watch multi-faced images without any feeling of heterogeneity.

Furthermore, there is an effect in that multi-faced images suitable for the structure of each movie screen can be generated because an image captured by a virtual camera is warped by taking into consideration a different structure of each movie screen.

Furthermore, the photographing configurations of sub-virtual cameras disposed on the left and right of a main virtual camera are identically adjusted based on the photographing configuration of the main virtual camera positioned at the center because a plurality of virtual cameras is used. Accordingly, there is an effect in that multi-faced images captured by the plurality of virtual cameras can form integrity.

Furthermore, regions photographed by a virtual camera are matched without overlapping the photographing regions of a camera disposed to neighbor each other. Accordingly, there is an effect in that multi-faced images can be generated more efficiently because a separate correction task is not necessary for a captured image.

Effects of the present invention are not limited to the above-described effects, and may include various other effects within the range evident to those skilled in the art from the following description.

### DESCRIPTION OF DRAWINGS

FIG. 1 is a diagram schematically showing the configuration of a multi-faced image generation apparatus according to an embodiment of the present invention.

FIG. 2 is a diagram schematically showing regions photographed by a single virtual camera according to an embodiment of the present invention.

FIG. 3A AND 3B is a diagram schematically showing the state in which a plurality of virtual cameras photographs a subject for photography according to an embodiment of the present invention.

FIG. 4A-4C is a diagram schematically showing the state in which the focal distance of a plurality of virtual cameras is adjusted according to an embodiment of the present invention.

FIGS. 5A-5D and 6A-6C are diagrams schematically showing the state in which resolution of a plurality of virtual cameras is adjusted according to an embodiment of the present invention.

FIG. 7 is a flowchart showing a flow of a method for the multi-faced image generation apparatus to generate multi-faced images using a virtual camera according to a second embodiment of the present invention.

FIG. 8 is a detailed flowchart of step S150 shown in FIG. 7.

FIG. 9A AND 9B illustrates a process of warping an image photographed by the multi-faced image generation apparatus according to an embodiment of the present invention.

FIG. 10A AND 10B shows the state in which images are previewed using the multi-faced image generation apparatus according to an embodiment of the present invention.

FIG. 11A-11C shows the state in which images having distortion corrected are previewed using the multi-faced image generation apparatus according to an embodiment of the present invention.

### DESCRIPTION OF REFERENCE NUMERALS

10: multi-faced image generation system
100: multi-faced image generation apparatus
110: virtual camera adjustment unit
120: photographing configuration unit
130: multi-faced image generation unit
140: preview generation unit
150: image warping unit

### MODE FOR INVENTION

Hereinafter, embodiments of the present invention are described in detail with reference to the accompanying drawings. The merits and characteristics of the present disclosure and a method for achieving the merits and characteristics will become more apparent from the embodiments described in detail in conjunction with the accompanying drawings. However, the present disclosure is not limited to the disclosed embodiments, but may be implemented in various different ways. The embodiments are provided to only complete the present disclosure and to allow those skilled in the art to fully understand the category of the present disclosure. The present disclosure is defined by the category of the claims. The same reference numerals will be used to refer to the same or similar elements throughout the drawings.

All terms (including technological and scientific terms) used in the specification, unless defined otherwise, will be used as meanings which can be understood by a person having ordinary skill in the art to which the present invention pertains in common. Furthermore, terms that are commonly used and defined in dictionaries should not be construed as having ideal or excessively formal meanings unless defined otherwise. Terms used in the specification are provided to describe the embodiments and are not intended to limit the present invention. In the specification, the singular form, unless specially described otherwise, may include the plural form.

Furthermore, a term, such as “comprise (or include)” and/or “comprising (or including)” used in the specification, do not exclude the existence or addition of one or more elements in addition to the described elements.

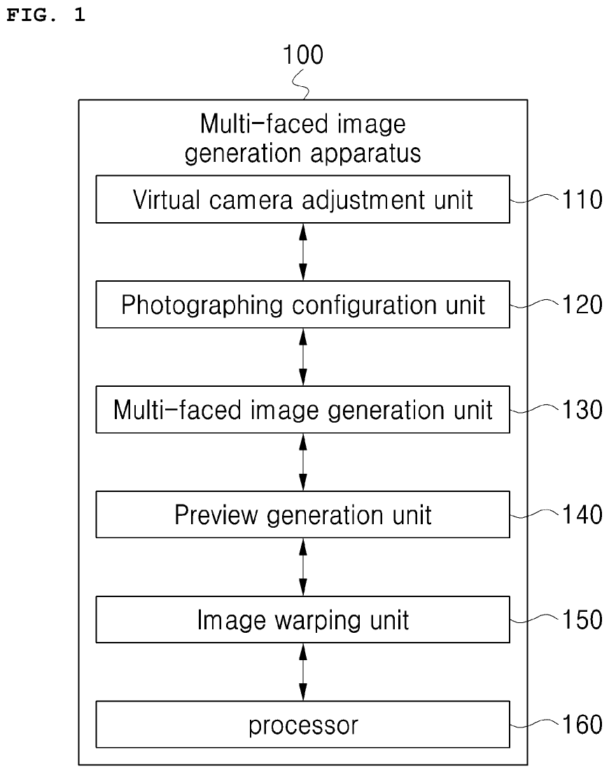

FIG. 1 is a diagram schematically showing the configuration of a multi-faced image generation apparatus 100 according to an embodiment of the present invention.

From FIG. 1, it may be seen that the multi-faced image generation apparatus 100 includes a virtual camera adjustment unit 110, a photographing configuration unit 120, a multi-faced image generation unit 130, a preview generation unit 140, an image warping unit 150 and a processor 160, and may further include an additional element for achieving an object of the present invention.

The virtual camera adjustment unit 110 may adjust the photographing configuration of the virtual camera 200. In this case, the virtual camera 200 is a virtual camera for generating multi-faced images and includes a single camera or a plurality of virtual cameras 200. The virtual camera may photograph a subject for photography at various angles and distances in a 3-D manner because it has photographing configuration information freely configured within a virtual 3-D space.

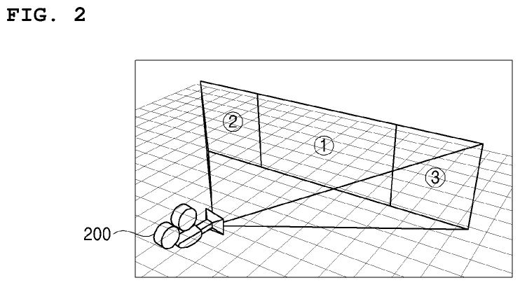

FIG. 2 is a diagram schematically showing regions photographed by a single virtual camera 200 according to an embodiment of the present invention. Referring to FIG. 2, multi-faced images to be projected on a movie screen may be generated using the single virtual camera 200. More specifically, multi-faced images may be generated by dividing a photographing region A, photographed by the virtual camera 200, by the number of regions in which the multi-faced images will be displayed. That is, it may be seen that a captured image is displayed in which display region because the boundary line of a virtual display surface is indicated in the photographing region A photographed the single virtual camera 200.

A display surface described in the present invention or a region to be displayed may include a surface from which an image is output, such as an LED or LCD, in addition to a surface on which an image may be projected using a projection apparatus, such as a screen, left and right wall surfaces, ceiling surface and bottom surface within a theater. That is, an image captured by the virtual camera 200 may be output using various projection methods within a movie screen. Each of display surface can be arranged in a non-parallel manner according to the structure of a theater.

Furthermore, in order to generate multi-faced images as described above, photographing resolution of the single virtual camera 200 may be set by taking into consideration horizontal/vertical resolution according to the number of display surfaces. For example, if an image to be projected on a screen including three display surfaces as in FIG. 2 is generated, horizontal resolution of the virtual camera 200 is the value of the sum of horizontal resolution of the display surfaces \textcircled{1}, \textcircled{2} and \textcircled{3}. Vertical resolution of the virtual camera 200 may be the same as the value of vertical resolution of the surface \textcircled{1}, that is, a center display surface, for the integration of images.

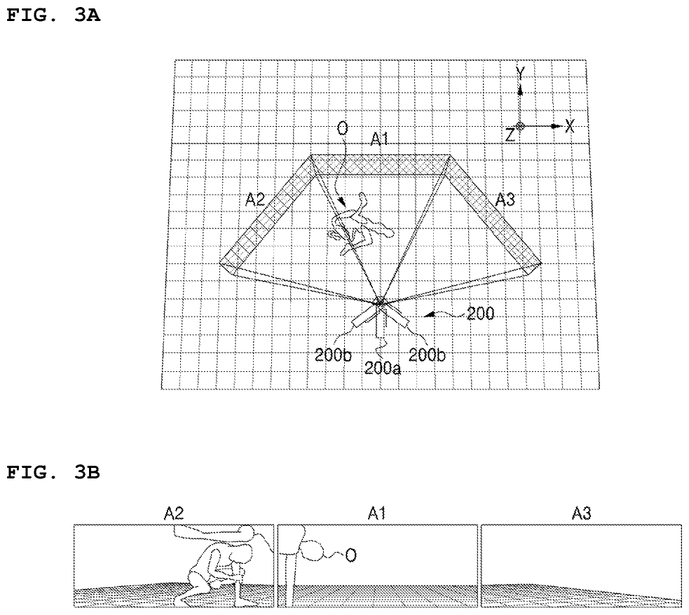

FIG. 3A AND 3B is a diagram schematically showing the state in which the plurality of virtual cameras 200 photographs a subject for photography according to an embodiment of the present invention. From FIG. 3A, it may be seen that the plurality of virtual cameras 200 is disposed in the same center axis of a Z axis when the bottom surface of a photographing space is viewed on an x-y plane and includes a main virtual camera 200a positioned at the center and sub-virtual cameras 200b disposed on both sides of the main virtual camera 200a. Furthermore, the plurality of virtual cameras 200 has the same center axis and is bound by a virtual rig. It may be seen that photographing configuration information of the plurality of virtual cameras 200 is identically set, each of the photographing regions A1, A2 and A3 of the plurality of cameras 200 that photograph a subject O for photography is matched with a neighboring photographing region without being overlapped.

Accordingly, multi-faced images of the subject O for photography captured by the plurality of cameras 200 are naturally connected as in FIG. 3B and do not have an overlap region. Furthermore, since the vertical sizes and horizontality of the multi-faced images are identically set, an additional edit task for cropping or stitching multi-faced images after photographing is not necessary.

The sub-virtual cameras 200b may be disposed on the upper and lower sides of the main virtual camera 200a in addition to the left and right of the main virtual camera 200a. Accordingly, the plurality of virtual cameras 200 is disposed in the same center axis of the X axis when they are viewed on the y-z plane of the photographing space. Surfaces on which images captured by the sub-virtual cameras 200b may be a ceiling surface and bottom surface within a movie screen.

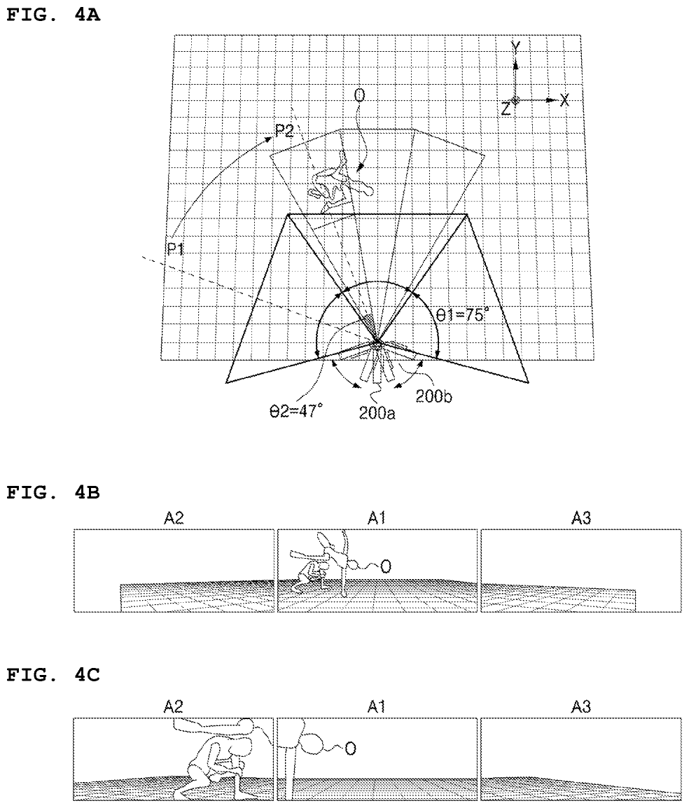

From FIGS. 4A to 6C, it may be seen that the virtual camera adjustment unit 110 may adjust a focal distance or resolution among photographing information of the plurality of cameras 200 and thus the photographing regions of the plurality of cameras 200 are controlled.

More specifically, the virtual camera adjustment unit 110 adjusts the photographing configuration of the sub-virtual cameras 200b based on the photographing configuration adjustment of the main virtual camera 200a so that the photographing configuration of the sub-virtual cameras 200b is connected to the photographing region of the main virtual camera 200a in order to prevent multi-faced images from overlapping.

Furthermore, the photographing configuration adjusted by the virtual camera adjustment unit 110 may include a focal distance and resolution. A region on which an image captured by the main virtual camera 200a is projected is the main screen of the movie screen, and display surfaces on which images captured by the sub-virtual cameras 200b are projected include the left and right wall surfaces of the main screen. The virtual camera adjustment unit 110 may adjust vertical resolution of the sub-virtual cameras 200b.

Furthermore, if display surfaces on which images captured by the sub-virtual cameras 200b are projected are a ceiling surface and a bottom surface on the basis of the main screen, the virtual camera adjustment unit 110 may make identical horizontal resolution of the sub-virtual cameras 200b and adjust the vertical resolution.

FIG. 4A-4C is a diagram schematically showing the state in which the focal distance of the plurality of virtual cameras 200 is adjusted according to an embodiment of the present invention. From FIG. 4A, it may be seen that if the focal distance of the plurality of virtual cameras 200a is 28 mm and a corresponding angle of view (θ1) is 750, when the virtual camera adjustment unit 110 adjusts the focal distance of the main virtual camera 200a to 50 mm, a corresponding angle of view (θ2) changes to 470 and the focal distance and angle of view of the sub-virtual camera 200b are identically adjusted.

Furthermore, when the focal distance and angle of view of the sub-virtual camera 200b are changed, the visual point of the sub-virtual camera 200b, that is, the optical axis of the virtual lens of the sub-virtual camera 200b, is not maintained, but is changed depending on the photographing region A1 of the main virtual camera 200a. For example, when the angle of view of the main virtual camera 200a is reduced as the focal distance of the main virtual camera 200a is reduced, the optical axis P1 of the virtual lens of the left sub-virtual camera 200b leans to the right, and the optical axis P2 of the virtual lens of the right sub-virtual camera 200b leans to the left. In contrast, when the angle of view of the main virtual camera 200a is increased as the focal distance of the main virtual camera 200a is increased, the optical axis of the lens of the right sub-virtual camera 200b moves. In this case, an angle at which the optical axis of the lens of the sub-virtual camera 200b moves may be the same as the angle of view (Δθ) of the main virtual camera 200a changed by the virtual camera adjustment unit 110.

Images captured by the plurality of virtual cameras 200 according to such focal distance adjustment are described below. From FIGS. 4B and 4C, it may be seen that multi-faced images captured by the plurality of virtual cameras 200 are naturally connected without being disconnected or overlapped. Accordingly, multi-faced images can be produced more easily.

Meanwhile, the virtual camera adjustment unit 110 may adjust resolution of the main virtual camera 200a. Accordingly, resolution of the sub-virtual camera 200b may be adjusted to be connected to the photographing region of the main virtual camera 200a.

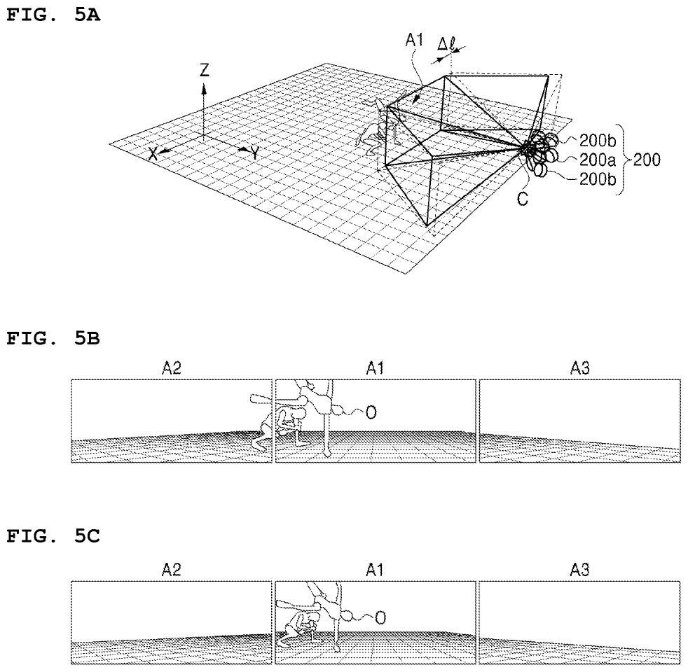

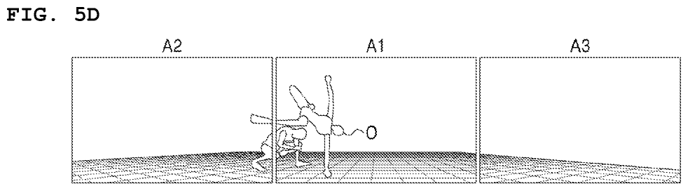

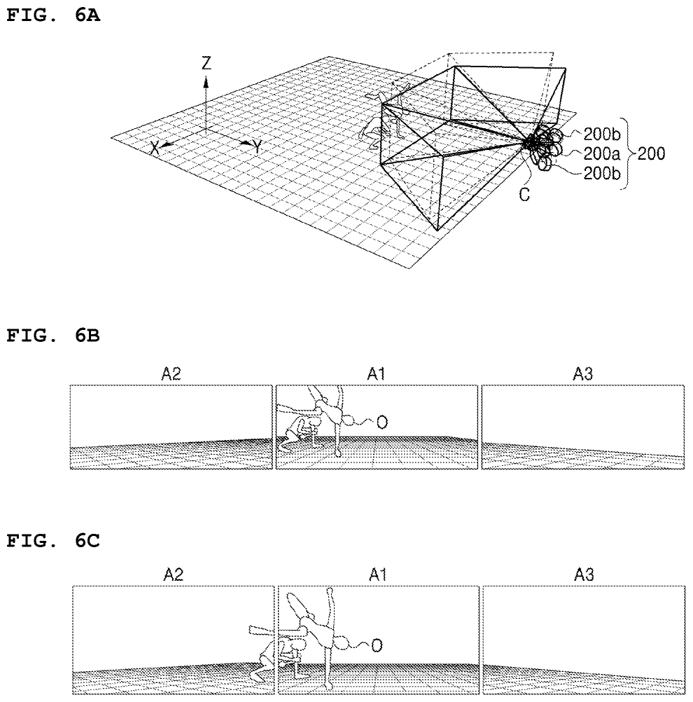

FIGS. 5A-5D and 6A-6C are diagrams schematically showing the state in which resolution of a plurality of virtual cameras 200 is adjusted according to an embodiment of the present invention.

From FIGS. 5A and 5B, it may be seen that if horizontal and vertical resolution of the plurality of virtual cameras 200 are 1920×1080 pix as in a solid line and corresponding photographing regions A1, A2 and A3 are as follows, when the virtual camera adjustment unit 110 adjusts horizontal and vertical resolution of the main virtual camera 200a to 1998*1080 pix as in a region indicated by a dotted line, the optical axis of the lens of the sub-virtual camera 200b is adjusted and the corresponding photographing regions are changed from FIG. 5B to FIG. 5C.

Furthermore, when the resolution of the sub-virtual camera 200b is adjusted, the visual point of the sub-virtual camera 200b, that is, the optical axis of the virtual lens, is not maintained, but is changed according to the photographing region A1 of the main virtual camera 200a. For example, when the horizontal length of the photographing region A1 increases as the horizontal resolution of the main virtual camera 200a increases, the center P1 of the virtual lens of the left sub-virtual camera 200b leans to the left and the optical axis P2 of the virtual lens of the right sub-virtual camera 200b leans to the right. In contrast, when the horizontal length of the photographing region A1 is reduced as the horizontal resolution of the photographing region A1 is reduced, the optical axis of the lens of the sub-virtual camera 200b moves. In this case, an angle at which the optical axis P1, P2 of the lens of the sub-virtual camera 200b moves may be the same as an angle formed by connecting a changed horizontal length A1 of the photographing region A1 photographed by the main virtual camera 200 and the center point C of the plurality of virtual cameras 200.

Furthermore, from FIGS. 5B and 5D, it may be seen that as the horizontal/vertical ratio of the main virtual camera 200a is changed, the subject O for photography enters the photographing region A1 of the main virtual camera 200a, but the subject O for photography is naturally connected without a disconnected or overlap part.

In another embodiment, the virtual camera adjustment unit 110 may adjust the vertical resolution of the main virtual camera 200b. For example, from FIG. 6A-6C, it may be seen that if horizontal and vertical resolution of the plurality of virtual cameras 200 are 1200×540 pix as in a solid line, when the virtual camera adjustment unit 110 adjusts the vertical resolution of the main virtual camera 200a to 700 pix, the vertical resolution of the sub-virtual camera 200b is identically adjusted to 700 pix. In this case, the visual point of the sub-virtual camera 200b, that is, the optical axis of the virtual lens of the sub-virtual camera 200b, may be maintained without any change.

As described above, the virtual camera adjustment unit 110 of the multi-faced image generation apparatus 100 has only to adjust the focal distance and resolution of the main virtual camera 200a, so the focal distances, resolution and optical axes of the lenses of the sub-virtual cameras 200b are automatically adjusted. Accordingly, an integrated multi-faced image contiguous to an edge where the photographing regions A1, A2 and A3 neighbor each other can be generated.

The multi-faced image generation apparatus 100 is described again with reference to FIG. 1.

The photographing configuration unit 120 configures a photographing section to be photographed by the virtual camera 200 having a photographing configuration adjusted by the virtual camera adjustment unit 110. For example, the photographing configuration unit 120 may include the photographing path, moving, etc. of a subject for photography of the virtual camera 200 according to the scenario of an image.

After the photographing section to be photographed by the virtual camera 200 is configured as described above, multi-faced images being captured by the virtual camera 200 may be previewed through the preview generation unit 140. Accordingly, a user may determine whether to generate multi-faced images based on aforementioned set items.

The multi-faced image generation unit 130 may generate matched first multi-faced images P1 captured by the virtual camera 200 having the photographing section configured. More specifically, the multi-faced image generation unit 130 may render images captured by the virtual camera 200 and store each the rendered image, or may integrate the images into a single image and may render and store the single image. In this case, the matching of the images means that the edges of left and right photographing images neighboring a center photographing image touch without being disclosed.

The image warping unit 150 may warp the first multi-faced image P1 generated by the multi-faced image generation unit 140. In this case, warping means that the first multi-faced image P1 is matched with various structures of a movie screen by applying distortion to the first multi-faced image.

In other words, the fabrication of multi-faced images may be completed by generating the matched first multi-faced images P1 using the virtual camera 200. When the matched first multi-faced images P1 are projected on a multi-faced movie screen on which the multi-faced images will be screen, the matched first images P1 may look distorted by an audience who sits down on a seat in the back row far from the multi-faced movie screen due to the nature of the structure of the movie screen of a ⊏ form or a form in which wall surfaces on both sides of the main screen are collected.

Accordingly, the image warping unit 150 may generate stable multi-faced images by warping the matched first multi-faced images P1 so that they do not look distorted. More specifically, the image warping unit 150 may generate a second multi-faced image P2 by identifying the structure of a movie screen on which the matched first multi-faced images P1 are projected and setting an image correction ratio suitable for the structure of the movie screen. In this case, the structure of the movie screen means a parameter indicative of structural dimensions within the movie screen. For example, the parameter of a movie screen used by the image warping unit 150 may include all numerical values associated with the region on which a multi-faced image is projected, such as an angle between a plurality of display surfaces within the movie screen, the horizontal and vertical lengths of a plurality of display surfaces (e.g., a screen, a left wall surface, a right wall surface, a ceiling surface and a bottom surface), the length from a screen to a seat at the front within the movie screen, and the height of a seat at the back.

Finally, it may be seen that the multi-faced image generation apparatus 100 includes the processor 160 configured to control the virtual camera adjustment unit 110, the multi-faced image generation unit 130, the preview generation unit 140 and the image warping unit 150. In some embodiments, the processor 160 is a central processing unit, and may include at least one operation device capable of controlling an overall operation of the multi-faced image generation apparatus 100. In this case, the operation device may be a general-purpose central processing unit (CPU), a programmable device element (CPLD, FPGA) implemented suitably for a specific object, application-specific integrated circuit (ASIC) or a microcontroller chip, for example.

The configuration of the multi-faced image generation apparatus 100 according to an embodiment of the present invention has been described so far. In accordance with an embodiment of the present invention, the multi-faced image generation apparatus 100 adjusts the photographing configuration of the single virtual camera 200 or the plurality of virtual cameras 200. Accordingly, multi-faced images can be easily produced because the regions of images projected on display surfaces within a movie screen do not overlap.

Hereinafter, a detailed method of producing multi-faced images using the multi-faced image generation apparatus 100 is described.

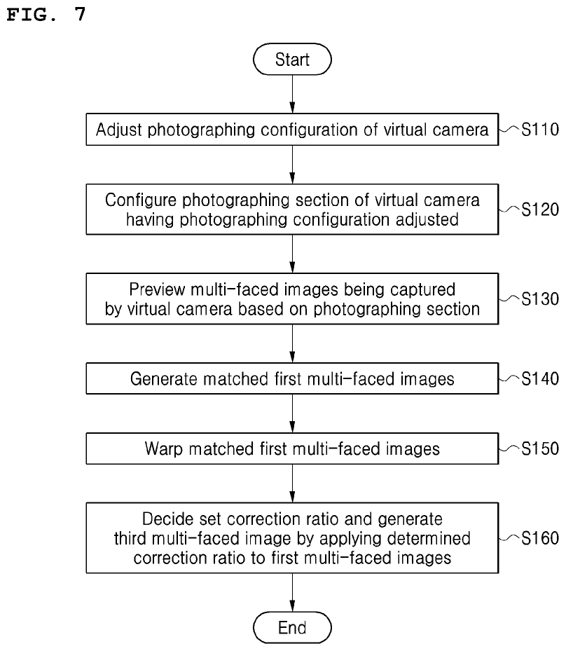

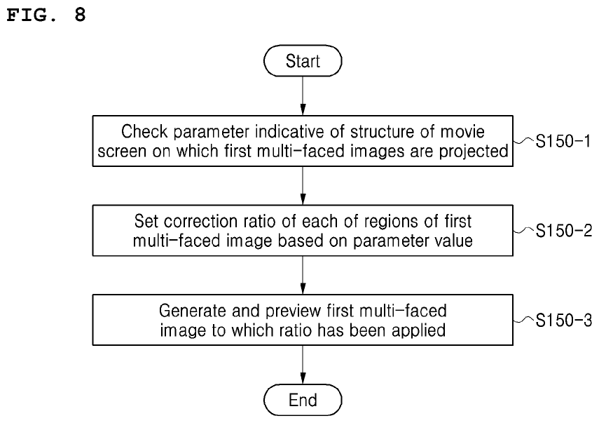

FIG. 7 is a flowchart showing a flow of a method for the multi-faced image generation apparatus 100 to generate multi-faced images using the virtual camera 200 according to a second embodiment of the present invention. The flowchart is only an embodiment for achieving an object of the present invention. In FIG. 7, some steps may be deleted or added if necessary, and any one step of the flowchart may be included in another step.

In order to generate multi-faced images projected on a multi-faced movie screen according to an embodiment of the present invention, a method using a single virtual camera and a method using a plurality of virtual cameras may be used as described above. Each of the methods is described below.

### Embodiment 1. Single Virtual Camera

First, the multi-faced image generation apparatus 100 adjusts the photographing configuration of the virtual camera 200 (S110). More specifically, horizontal and vertical resolution of a region photographed by the single virtual camera 200 may be set by taking into consideration the center display surface, left and right (left and right wall surfaces) display surfaces or top and bottom (ceiling surface and bottom surface) display surfaces of the movie screen.

For example, if resolution of a front display surface is set to 1920×1080 pix and resolution of left and right display surfaces is set to 1998*1080 pix, the multi-faced image generation apparatus 100 may set resolution of the single virtual camera to 5916 (1998+1920+1998)×1080 pix. In this case, vertical resolution may be identically set for the integrity of screens.

After step S110, the multi-faced image generation apparatus 100 configures a photographing section to be photographed by the single virtual camera 200 having the photographing configuration adjusted (S120). For example, the multi-faced image generation apparatus 100 may configure the photographing path, moving, etc. of a subject for photography of the virtual camera 200 according to the scenario of content.

Step S110 of configuring photographing and step S120 of configuring a photographing section are performed using the virtual camera 200. Accordingly, a user can preview the photographing configuration and photographing section of the virtual camera 200 that are changed in real time, and can identify whether the photographing configuration and the photographing section have been correctly configured. Accordingly, a user can produce a multi-faced image more efficiently because the multi-faced image is prevented from being differently produced as intended.

After step S120, the multi-faced image generation apparatus 100 previews a multi-faced image captured by the single virtual camera 200 (S130). To this end, the multi-faced image photographed by the virtual camera 200 may include the structure of a movie screen and a display surface guide line suitable for corresponding resolution. Accordingly, a user can check that a captured image is displayed on which display surface within a movie screen.

A user may view captured multi-faced images in a panorama form or may view the captured multi-faced images in a form, such as that they are actually projected on a movie screen, or may wear a head mount display (HMD) and view a corresponding multi-faced image in a 3-D manner. Furthermore, the user may determine whether to generate multi-faced images based on aforementioned items.

After step S130, the multi-faced image generation apparatus 100 obtains an image of a subject O for photography captured by the virtual camera 200 having a photographing configuration adjusted, and generates matched first multi-faced images P1 (S140). The first multi-faced image P1 generated in this process has been captured by the single virtual camera 200. Accordingly, the multi-faced image generation apparatus 100 may split and generate the first multi-faced image P1 based on resolution of a display surface, may render the image, and may store the rendered image or may render an integrated first multi-faced image P1 that has not been split and store the rendered image.

After the matched first multi-faced image P1 suitable for a scenario is generated through step S140, the multi-faced image generation apparatus 100 warps part of the first multi-faced image P1 that may look distorted depending on the structure of the movie screen (S150). That is, the multi-faced image generation apparatus 100 may generate a warping value (i.e., correction ratio value) suitable for the structure of the movie screen, and may provide a preview image by applying the warping value to the first multi-faced image P1 so that a user can identify whether distortion has been corrected in real time.

After step S150, the multi-faced image generation apparatus 100 may generate a third multi-faced image P3 by applying the warping value, determined by the user, to the first multi-faced image P1, and may store the finally completed third multi-faced image P3 as an integrated image or images split into respective display surfaces.

### Embodiment 2. Plurality of Virtual Cameras

The multi-faced image generation apparatus 100 adjusts the photographing configurations of the plurality of virtual cameras 200 (S110). In this case, the plurality of virtual cameras 200 may include \textcircled{1} the main virtual camera 200a positioned at the center in the same Z direction center axis and the sub-virtual cameras 200b disposed on the left and right of the main virtual camera 200a or \textcircled{2} the main virtual camera 200a positioned at the center in the same X-axis direction center axis and the sub-virtual cameras 200b disposed at the top and bottom of the main virtual camera 200a and \textcircled{3} the sub-virtual cameras 200b disposed at the top, bottom, left and right of the main virtual camera 200a.

The multi-faced image generation apparatus 100 may adjust the photographing configuration of the main virtual camera 200a. The sub-virtual cameras 200b may be adjusted so that respective photographing regions do not overlap based on the photographing configuration of the main virtual camera 200a.

For example, the photographing configuration adjusted in the sub-virtual camera 200b includes the focal distance or vertical resolution of a virtual camera. Accordingly, the multi-faced image generation apparatus 100 may obtain a single integrated multi-faced image in which images do not overlap or the images are not dislocated by adjusting the focal distance or vertical resolution of the virtual camera.

After step S110, the multi-faced image generation apparatus 100 configures photographing sections to be photographed by the plurality of virtual cameras 200 having the photographing configuration adjusted (S120). For example, the multi-faced image generation apparatus 100 may configure the photographing path, moving, etc. of a subject for photography of the virtual camera 200 according to the scenario of content.

After step S120, the multi-faced image generation apparatus 100 previews multi-faced images captured by the plurality of virtual cameras 200 (S130). In this case, the preview process may be performed in the same manner in which the single virtual camera 200 is used. That is, a user may view captured multi-faced images in a panorama form or in an image form, such as that actually projected on a movie screen, or may wear a head mount display (HMD) and view a corresponding multi-faced image in a 3-D manner. The user may determine whether to generate a multi-faced image based on aforementioned items.

Step S110 of configuring photographing and step S120 of configuring a photographing section are performed using the virtual camera 200. Accordingly, a user can preview the photographing configuration and photographing section of the virtual camera 200 that are changed in real time, and can identify whether the photographing configuration and the photographing section have been correctly configured. Accordingly, a user can produce multi-faced images more efficiently because the multi-faced images are prevented from being differently produced as intended.

After step S130, the multi-faced image generation apparatus 100 may generate matched first multi-faced images P1 by obtaining images of a subject O for photography captured by the plurality of virtual cameras 200 having the photographing configuration adjusted (S140), and may render and store the images. In this case, the multi-faced image generation apparatus 100 may integrate and store the images in the form of the integrated first multi-faced image P1.

After the matched first multi-faced images P1 suitable for the scenario are generated through step S140, the multi-faced image generation apparatus 100 warps part of the first multi-faced images P1 that may look distorted depending on the structure of the movie screen (S150). That is, the multi-faced image generation apparatus 100 may generate a warping value (i.e., correction ratio value) suitable for the structure of the movie screen, and may provide a preview image by applying the warping value to the first multi-faced image P1 so that a user can identify whether distortion has been corrected in real time.

After step S150, the multi-faced image generation apparatus 100 may generate a third multi-faced image P3 by applying the warping value, determined by the user, to the first multi-faced image P1, and may store the finally completed third multi-faced image P3 as an integrated image or as images split into respective display surfaces.

A method for the multi-faced image generation apparatus 100 to generate multi-faced images using a single camera or a plurality of the virtual cameras 200 according to an embodiment of the present invention has been described so far. Hereinafter, a method of correcting the distortion of the first multi-faced image P1 briefly described at step S150 is described specifically. This method may be performed in the same manner regardless of the number of virtual cameras 200.

FIG. 8 is a detailed flowchart of step S150 shown in FIG. 7.

Referring to FIG. 8, the multi-faced image generation apparatus 100 identifies that the first multi-faced image P1 photographed through step S140 is projected on which movie screen, and checks a parameter value indicative of the structure of a movie screen on which the image is projected (S150-1). In this case, the parameter value may include an angle between a plurality of display surfaces within the movie screen, the horizontal and vertical lengths of the plurality of display surfaces (e.g., a screen, a left wall surface, a right wall surface, a ceiling surface and a bottom surface), the length from a screen to a seat at the front within the movie screen, and the height of a seat at the back.

When the structure of the movie screen is checked through Step S150-1, the multi-faced image generation apparatus 100 sets the correction ratio of each of the regions of the first multi-faced image P1 based on the parameter value (S150-2).

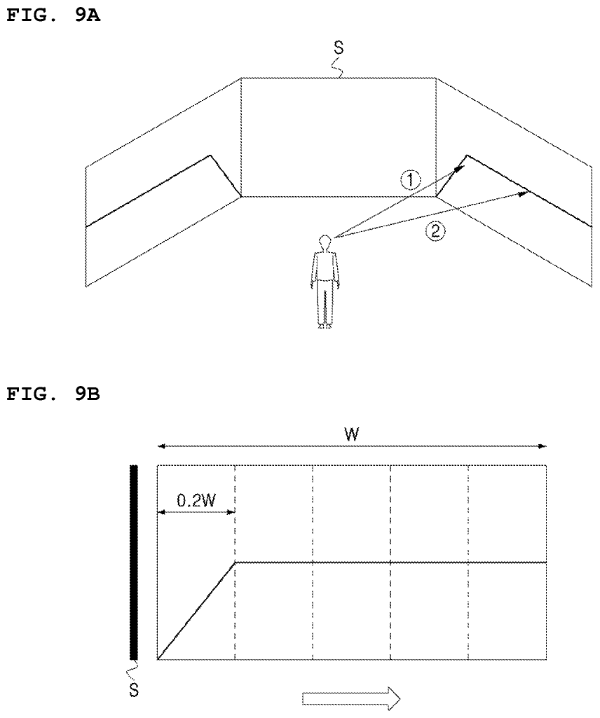

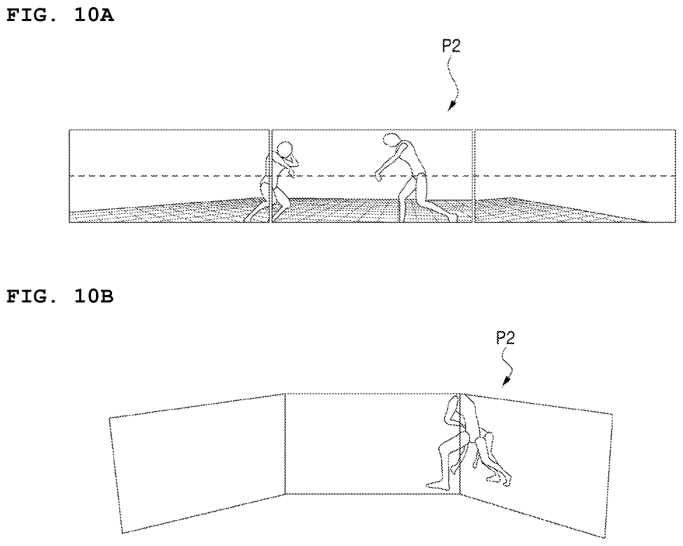

FIG. 9A AND 9B illustrates a process of warping an image photographed by the multi-faced image generation apparatus 100 according to an embodiment of the present invention. Referring to FIG. 9A, an image in the No. \textcircled{1} region of a right display surface positioned at a distant place visually may look small by an audience who sits down on a seat in the back row on the right of a screen S, and an image in the No. \textcircled{2} region of the right display surface positioned at a close place may look large by the audience. Accordingly, if the first multi-faced image P1 is projected on a movie screen without any change, multi-faced images produced to provide a stereoscopic effect to audiences may hinder an audience's image watching or reduce a degree of concentration.

Accordingly, the multi-faced image generation apparatus 100 may partition each of the display surfaces disposed on the left and right of the screen S for each region, and may edit a first multi-faced image P1, projected on each region, based on a correction ratio set for each region.

For example, referring to FIG. 9B, the multi-faced image generation apparatus 100 may divide the right display surface into five equal parts by taking into consideration a total horizontal length W of the right display surface identical with a total depth of the movie screen, the length of the screen S similar to a total width of the movie screen, the height of an audience seat in the first row, and the height up to an audience seat in the last row. The multi-faced image generation apparatus 100 may slowly decrease the ratio of the first multi-faced image P1 up to a region that belongs to the five equally-divided regions and that indicates a value 0.2 W close to the screen S. That is, the multi-faced image generation apparatus 100 may generate a second multi-faced image P2 to which a correction ratio has been finally applied by slowly decreasing the first multi-faced image P1 from the original size up to a 20% region that belongs to the right display surface and that is close to the screen S and maintaining the ratio of the reduced first multi-faced image P1 in the remaining 80% region.

A method of checking the ratio by specifically calculating the parameter of each movie screen may be most preferred. In some embodiments, various methods of randomly dividing first multi-faced images P1 projected on left and right display surfaces without specifically checking and calculating a parameter and providing correction ratios reduced 100%, 90% and 80% in order of distance far from the screen S or of setting the correction ratio or weight of each region of the display surface by taking into consideration an angle between a plurality of display surfaces within a movie screen may be performed.

Referring back to FIG. 8, after step S130-2, the multi-faced image generation apparatus 100 may generate a second multi-faced image P2 to which the correction ratio has been applied and preview the second multi-faced image (S150-3), and may identify whether the multi-faced images have been edited based on a required correction ratio.

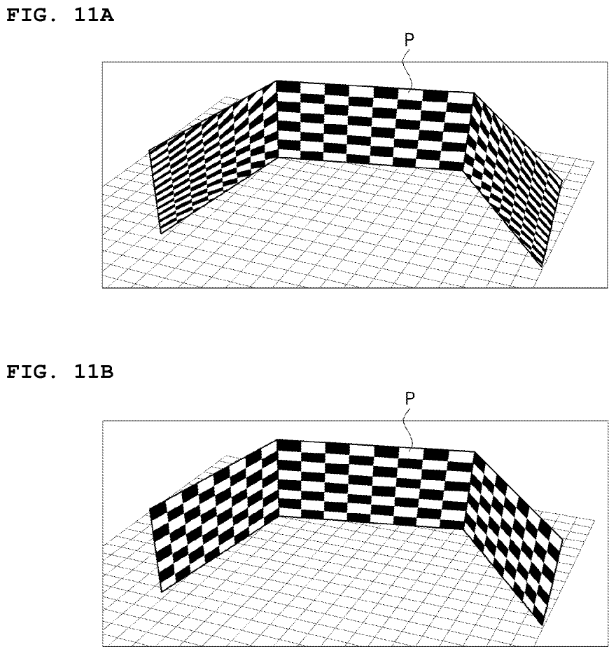

In the step of generating the multi-faced images and correcting distortion, a user may watch a preview image output in various manners. This is described below with reference to FIG. 10A AND 10B.

FIG. 10A AND 10B shows the state in which images are previewed using the multi-faced image generation apparatus 100 according to an embodiment of the present invention.

From FIG. 10A AND 10B, it may be seen that a preview screen of second multi-faced images P2 provided by the multi-faced image generation apparatus 100 are displayed in a panorama image form as shown in FIG. 10A. That is, images captured by the plurality of virtual cameras 200 may be aligned in a row. Furthermore, the preview screen may be displayed in the form of 3-D images combined identically with the structure of a movie screen as shown in FIG. 10B or may be displayed in the form of a 3-D image which can be watched by a user who has worn a head mount display (HMD).

As described above, a user who uses the multi-faced image generation apparatus 100 can simulate how multi-faced images are displayed within a multi-faced movie screen, while watching the multi-faced images from a viewpoint of an audience within a movie screen or watching them in a panorama form in which the images are aligned in a line, and can easily identify whether correction according to distortion is correctly performed.

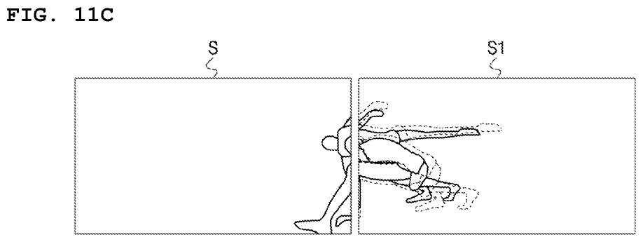

FIG. 11A-11C shows the state in which images having distortion corrected are previewed using the multi-faced image generation apparatus 100 according to an embodiment of the present invention. Referring to FIGS. 11A and 11B, when a first multi-faced image P1 is warped based on the structure of a movie screen, a user can view a second multi-faced image P2 having distortion corrected, such as that shown in FIG. 11C. More specifically, a user can check whether the ratio of an image projected on a right display surface S1 has been reduced compared to an image projected on a screen S, and can check the second multi-faced image P2 to which a correction ratio has been applied using a 3-D image in addition to a panorama form.

As described above, the multi-faced image generation apparatus 100 according to an embodiment of the present invention has an effect in that audiences can be further immersed in a corresponding image because a multi-faced image photographed based on an audience's visual point and the structure of a movie screen is warped for each region. Furthermore, the plurality of virtual cameras 200 has the same photographing configuration, and photographing regions have been matched. Although warping is performed based on the structure of a movie screen, the finally produced third multi-faced image P3 can form integrity without a feeling of heterogeneity.

The present invention may be implemented in a computer-readable recording medium in the form of code readable by a computer. The computer-readable recording medium includes all of storage media, such as a magnetic storage medium and an optical recording medium. Furthermore, in an embodiment of the present invention, the data format of a message used may be recorded in a recording medium.

As described above, although the embodiments of the present invention have been described with reference to the accompanying drawings, those skilled in the art to which the present invention pertains will appreciate that the present invention may be implemented in other detailed forms without changing the technical spirit or essential characteristics of the present invention. Accordingly, the above-described embodiments should be construed as being only illustrative from all aspects not as being restrictive.

1. A method of generating multi-faced images using a virtual camera, comprising steps of:
adjusting, by a multi-faced image generation apparatus, a photographing configuration of a virtual camera;
configuring, by the multi-faced image generation apparatus, a photographing section of the adjusted virtual camera; and
generating, by the multi-faced image generation apparatus, matched first multi-faced images captured by the virtual camera based on the configured photographing section.

2. The method of claim 1, further comprising a step of previewing multi-faced images being captured by the virtual camera based on the photographing section prior to the step of generating the first multi-faced images.

3. The method of claim 1, further comprising a step of warping the first multi-faced images after the step of generating the first multi-faced images.

4. The method of claim 3, wherein the step of warping the first multi-faced images comprises steps of:
checking a parameter indicative of a structure of a movie screen on which the first multi-faced images are projected; and
setting a correction ratio for each display surface of the first multi-faced images based on the checked parameter.

5. The method of claim 4, further comprising a step of generating and previewing a second multi-faced image to which the ratio has been applied after the step of setting the correction ratio of each region.

6. The method of claim 5, further comprising steps of:
determining the set correction ratio after the step of previewing the second multi-faced image, and
generating a third multi-faced image by applying the determined correction ratio to the matched first multi-faced images.

7. The method of claim 1, wherein the step of adjusting the photographing configuration comprises a step of adjusting horizontal and vertical resolution of at least one of a center display surface and left and right or up and down display surfaces of a movie screen if the virtual camera is a single virtual camera.

8. The method of claim 1, wherein the step of generating the first multi-faced images comprises a step of generating the first multi-faced images by dividing a first multi-faced image, captured by a single virtual camera, based on display surfaces of a movie screen if the virtual camera is the single virtual camera.

9. The method of claim 1, wherein:
the virtual camera comprises a plurality of virtual cameras, and
the plurality of virtual cameras comprises:
a main virtual camera corresponding to a center display surface of a movie screen; and
sub-virtual cameras disposed on left and right or top and bottom of the main virtual camera.

10. The method of claim 9, wherein the step of adjusting the photographing configuration comprises a step of adjusting photographing configurations of the sub-virtual cameras so that a photographing region of the main camera and photographing regions of the sub-virtual cameras are connected.

11. A multi-faced image generation apparatus, comprising:
a virtual camera adjustment unit configured to adjust a photographing configuration of a virtual camera;
a photographing configuration unit configured to configure a photographing section of the virtual camera having the photographing configuration adjusted;
a multi-faced image generation unit configured to generate matched first multi-faced images captured by the virtual camera having the photographing section configured; and
a processor configured to control one or more of the virtual camera adjustment unit, the photographing configuration unit and the multi-faced image generation unit.

12. The multi-faced image generation apparatus of claim 11, further comprising a preview generation unit configured to preview multi-faced images being captured by the virtual camera based on the photographing section configured by the photographing configuration unit.

13. The multi-faced image generation apparatus of claim 12, further comprising an image warping unit configured to warp the first multi-faced images generated by the multi-faced image generation unit.

14. The multi-faced image generation apparatus of claim 13, wherein the image warping unit is configured to:
check a parameter indicative of a structure of a movie screen on which the first multi-faced images are projected; and
set a correction ratio for each region of the first multi-faced images based on the checked parameter.

15. The multi-faced image generation apparatus of claim 14, wherein the preview generation unit is configured to generate and preview a second multi-faced image to which the ratio has been applied after the correction ratio of each region is set.

16. The multi-faced image generation apparatus of claim 15, wherein the image warping unit is configured to:
determine the set correction ratio after the step of previewing the second multi-faced image, and
generate a third multi-faced image by applying the determined correction ratio to the matched first multi-faced images.

17. The multi-faced image generation apparatus of claim 11, wherein the virtual camera adjustment unit is configured to adjust horizontal and vertical resolution of at least one of a center display surface and left and right or up and down display surfaces of a movie screen if the virtual camera is a single virtual camera.

18. The multi-faced image generation apparatus of claim 11, wherein the multi-faced image generation unit is configured to generate the first multi-faced images by dividing a first multi-faced image, captured by a single virtual camera, based on display surfaces of a movie screen if the virtual camera is the single virtual camera.

19. The multi-faced image generation apparatus of claim 11, wherein:
the virtual camera comprises a plurality of virtual cameras, and
the plurality of virtual cameras comprises:
a main virtual camera corresponding to a center display surface of a movie screen; and
sub-virtual cameras disposed on left and right or top and bottom of the main virtual camera.

20. The multi-faced image generation apparatus of claim 19, wherein the photographing configuration unit is configured to adjust photographing configurations of the sub-virtual cameras so that a photographing region of the main camera and photographing regions of the sub-virtual cameras are connected.
